(19) United States
(12) Patent Application Publication
(10) Pub. No.: US 2007/0005552 A1
(43) Pub. Date: Jan. 4, 2007

(54) Methods and systems for reducing transient memory consumption in an object-oriented system

(76) Inventors: Udo Klein, (US); Rene Gross, Schwarzach (DE); Martin Kalser, Speyer (DE); Rene Dehn, (US); Glsells Domlnguez Anzulnell, (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/171,210

(22) Filed: Jul. 1, 2005

(51) Int. Cl. G06F 17/30

(52) U.S. Cl. 707/1

(57) ABSTRACT

Systems and methods are disclosed for reducing the consumption of transient memory in an object-oriented system. The disclosed systems and methods may include a request by an application for the content of an object from an application to a database via a buffer. The requested content may be returned to the application from the database via the buffer without storing the content in the buffer. The buffer may also store portions of the content of the object that are edited by the requesting application. Upon receiving another request for the content of the object from the application, the buffer may determine whether it has previously stored any edited portion of the object content and, if so, to update the object content retrieved from the database with the edited portion before returning it to the application.

### BACKGROUND OF THE INVENTION

I. Field of the Invention

The present invention generally relates to methods and systems for reducing transient memory consumption in an object-oriented system. More particularly, the present invention relates to reducing memory and performance overhead typically encountered in object-oriented systems.

II. Background Information

Because it offers several advantages over alternative methods, object-oriented programming (OOP) has become popular with software developers in recent years. Unlike previously preferred approaches, OOP programming focuses on data rather than procedure, binding data closely to the functions that operate on it. Typically, objects comprise data and algorithms. An object's data may describe the state of the object. Object algorithms, sometimes called functions, may accomplish a wide variety of tasks, including but not limited to: changing the state of the object; generating output; and sending messages to other objects. For example, upon receiving a message instructing it to perform a particular operation, an object may be operative to execute the algorithm necessary to accomplish that operation.

OOP offers several advantages over other programming approaches. For instance, the data of an object may be encapsulated, meaning that it is hidden from external functions, and is thus protected from modification by external users or applications. OOP also allows developers to represent essential features in the abstract, allowing background details or explanations to be hidden from the user. By representing essential features in the abstract, the length of code necessary to accomplish a task is minimized. Reducing the length of code is beneficial because it reduces the opportunity for mistake and makes the code easier to maintain. Further, code written at a high level of abstraction is more easily accessible to tools for analyzing and optimizing code.

A disadvantage of OOP, however, is that it often allocates a large amount of memory and performance overhead. Particularly with regard to large computer networks with hundreds or thousands of users, the memory and performance requirements that come with object-oriented applications can drain resources, necessitating a higher investment in hardware or leading to wasted man-hours, due to increased computing time.

Typically, object-oriented systems allow applications access to objects in one of two ways. In the first, an application requests objects from a database through a database access layer. Objects returned to the application are stored in transient memory. As an application may request a large number of objects, the demand on temporary memory may be very large. Transient memory occupied by the object instances requested by the application will not be released until the session in which the objects were requested is terminated. Further, if a request is made for the same object within the same session, a second copy of that object will be stored in the temporary memory, compounding the demands on the system and negatively impacting performance. Duplicate copies in transient memory also creates difficulty in determining which copy is up-to-date, potentially leading to the loss of information or saving incorrect information to the database.

FIG. 1 illustrates a system known in the art in which no buffer is present between applications and the underlying database. In stage 1, an application 10 is shown requesting an object 12 from database 16 through a database access layer 18. Database access layer 18 serves to translate the request from application 10 to database 16 (stage 2) and return the requested object from database 16 to application 10 (stage 3). Database access layer 18 has no capability to determine whether a request for object 12 was previously made during a current session, and therefore has no way of determining if a copy of object 12 already exists in temporary memory. Therefore, each time application 10 makes a request for object 12 during the same session, database access layer 18 returns a new copy of object 12 to application 10 (stage 4) and that new copy is stored in the system's temporary memory. This is demonstrated in stages 5-8 of FIG. 1, in which application 10 makes another request for object 12, leading to creation of a second copy of object 12 in transient memory. The creation of duplicate copies bloats temporary memory, and may also cause confusion as to which copy is the most recent and/or accurate.

In an attempt to prevent the storage of multiple versions of the same object in temporary memory, buffers have been introduced between applications and the underlying database. Under this approach, an application may make a request to the database for an object through the buffer. The buffer is operative to create instances of the requested objects in temporary memory. The buffer references the object instances, allowing the application to read and work in the object instances through the buffer. When a buffer receives a request for an object from an application, it is operative to determine whether it has already created an instance of the object in temporary memory. If an object instance is already referenced by the buffer, the previously stored instance is returned to the application without creating a second instance of the object. The buffer, therefore, is operative to prevent creation of multiple instances of the same object in temporary memory. However, the buffer is not able to determine when the requesting application no longer requires the object instance. Accordingly, the buffer will maintain all object instances created in response to a request from an application until the session is terminated. Needlessly maintained object instances can be vast in number, and because each file may be large in its own right, memory capacity and system performance can be severely hindered, even when a buffer is provided.

FIG. 2 illustrates a system known in the art comprising one or more applications 20, a buffer 22 and an underlying database 24. In stage 1, application 20 requests an object 26 from database 24 via buffer 22. Buffer 22 is operative to store instances of objects requested by application 20 in transient memory. Buffer 22 is also operative to determine whether it has already created an instance of object 26 during a current session (stage 2). If buffer 22 has not previously stored an instance of object 26, it accesses object 26 from database 24 (stage 3) and creates an instance of object 26 in transient memory (stage 4) before returning it to application 20 (stage 5). If application 20 makes another request for object 26 during the same session (stage 6), buffer 22 is operative to determine that it has already created an instance of object 26 (stage 7) and returns the stored copy to application 20 (stage 8). However, buffer 22 is not operative to determine when application 20 no longer requires object instances created by buffer 22, and therefore does not know when to discard the instances stored in transient memory. Particularly in mass-processing operations, in which numerous objects may be requested during a single session, the demand on temporary memory can seriously hamper system performance.

### SUMMARY OF THE INVENTION

Consistent with embodiments of the present invention, systems and methods for reducing memory consumption in an object-oriented system are provided.

In accordance with one embodiment, a method for reducing memory consumption in an object-oriented system may comprise transmitting a first request for content of an object from an application to a database via a buffer. The method may further comprise returning the requested content from the database to the application via a buffer. Upon editing of a portion of the requested content by the application, the method may include storing only the edited portion of the content in the buffer. The method may further comprise, upon transmission of a second request from the application for the content of the object, retrieving the requested content from the database, determining whether the buffer contains any previously edited portion of the content and, if so, updating the content retrieved from the database with the edited portion before returning the requested content to the application.

According to another embodiment, a system for reducing memory consumption in an object-oriented system may comprise a database containing an object. The system may further include comprising a symbolic object reference associated with the object, wherein an application may retrieve content of the object through the proxy. The system may further comprise a buffer operative to store content of the object edited by the application in transient memory. Upon a request by the proxy for the object contained in the database, the buffer may be operative to determine whether the buffer has previously stored any edited content of the requested object and, if so, to update the content of the object retrieved from the database with the edited content before returning it to the database via the proxy.

In accordance with yet another embodiment, a computer-readable medium which stores a set of instructions which when executed performs a method for reducing memory consumption in an object-oriented system is provided. The computer-readable medium may be executed by a set of instructions comprising creating a proxy associated with an object contained in a database, the proxy being engageable by an application to request content of the object from the database. The method may further comprise engaging the proxy to request the object content from the database via a buffer and retrieving the object content from the database. The method may also include determining whether the buffer contains edited content of the object and, if so, updating the content of the object retrieved from the database with the edited content and returning the content of the object to the requesting application via the proxy.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates the operation of an object-oriented system known in the art.

FIG. 2 illustrates the operation of another object-oriented system known in the art.

FIG. 3 illustrates the operation of an object-oriented system consistent with the principles of the present invention.

FIG. 4 illustrates an object-oriented system known in the art.

FIG. 5 illustrates an object-oriented system consistent with the principles of the present invention.

FIG. 6 illustrates an object-oriented system consistent with the principles of the present invention comprising a facade.

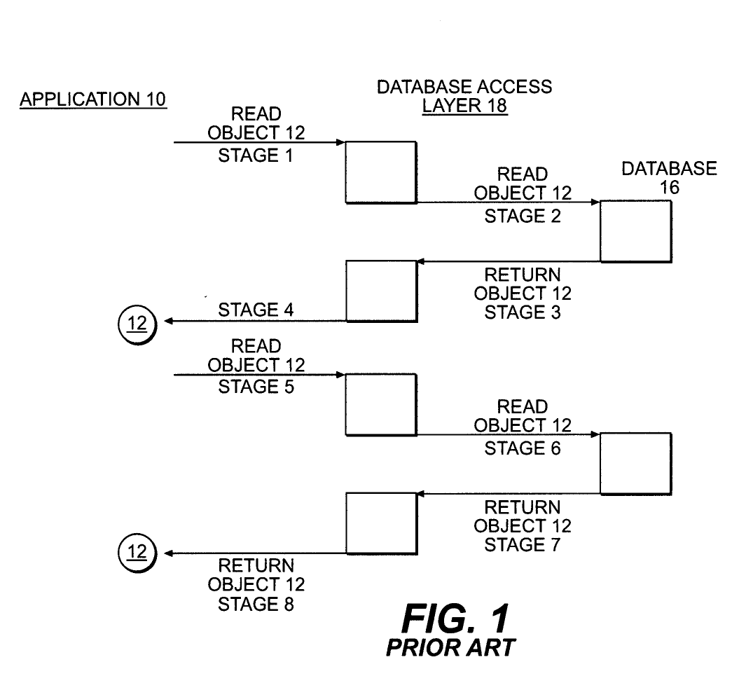

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible without departing from the spirit and scope of the invention. For example, substitutions, additions and/or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

As embodied herein, methods and systems for reducing memory consumption in an object-oriented system are provided. The system may contain a buffer that serves as an interface between applications requesting objects and a database containing the objects. Each object contained within a database may be associated with a globally unique identifier (GUID). In one aspect, applications may use the GUID to request objects from the database. The buffer may return the requested objects from the database to the requesting application. The buffer may be configured such that it stores no data from the requested objects in transient memory unless the application edits any data of the requested object. If the application edits content of the requested object, the buffer may store in temporary memory only the GUID of that object and the portion of the data that was edited, rather than storing the entire content of the object. Thus, upon receiving a request for an object from an application, the buffer may determine, based on the GUID of the requested object, whether it has stored any edited information in temporary memory, and if not, to return the requested object to the application from the database. If the buffer has already stored edited content relating to the requested object in a current session, it may retrieve the object from the database and update it with the stored edited information before returning it to the application.

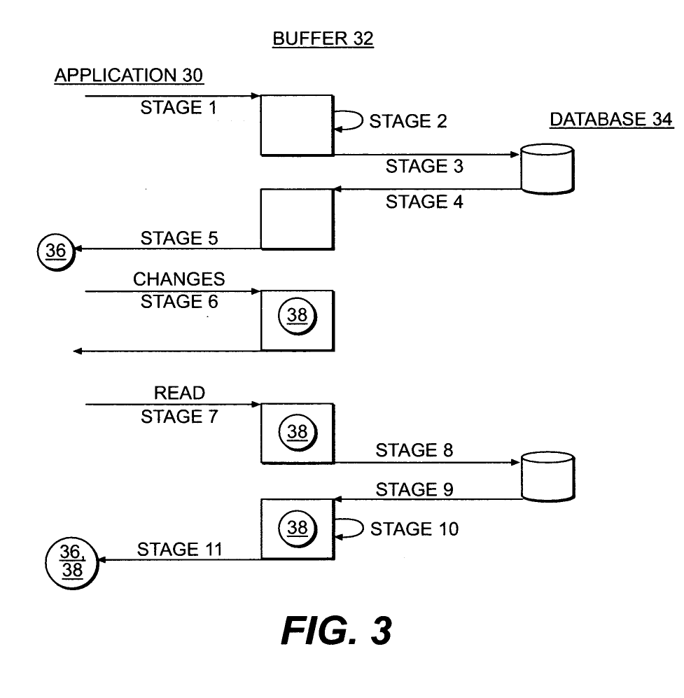

FIG. 3 is a flow diagram illustrating the operation of a system consistent with the principles of the present invention is provided. The system may comprise one or more applications 30, a buffer 32 and an underlying database 34. As illustrated in stage 1, application 30 may request an object 36 from database 34 via buffer 32. In response to the request, buffer 32 may determine whether it has previously stored information relating to object 36 in temporary memory in a current session (stage 2). Buffer 32 may also send a request for object 36 to database 34 (stage 3). If buffer 32 has previously stored information relating to object 36 in temporary memory, it may update object 36 with that information (stage 4). Buffer 32 may then return object 36 to application 30 (stage 5). If application 30 then edits any information of either object 36, buffer 32 may store an edited portion 38 of the data in temporary memory (stage 6). As shown in stages 7-11, if application 30 then makes another request for object 36, buffer 32 may update object 36 with edited content 38 before returning object 36 to application 30. In one aspect, if edits made by application 30 to a requested object and stored in buffer 32 are saved to the object stored in database 34, buffer 32 may delete the edited information from temporary memory.

Oftentimes, only a small portion of the total content of an object need be edited during a session, and therefore only a small portion of the object need be stored in temporary memory during the editing session. Moreover, if no content of a requested object is edited by the requesting application, no portion of the requested object need be stored in temporary memory. Thus, the demand on temporary memory may be greatly reduced.

Consistent with the principles of the present invention, each object contained within database 34 may be associated with a GUID. Buffer 32 may store the portion of an object's content edited by an application. Buffer 32 may be associate the stored data with the object GUID. Because applications may request objects based on their GUIDS, buffer 32 may locate any edited information of that object by searching its memory for the GUID of the requested object.

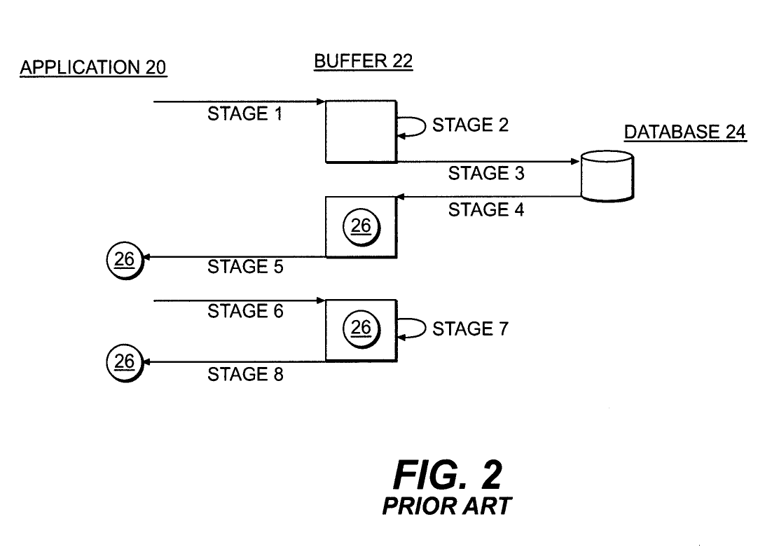

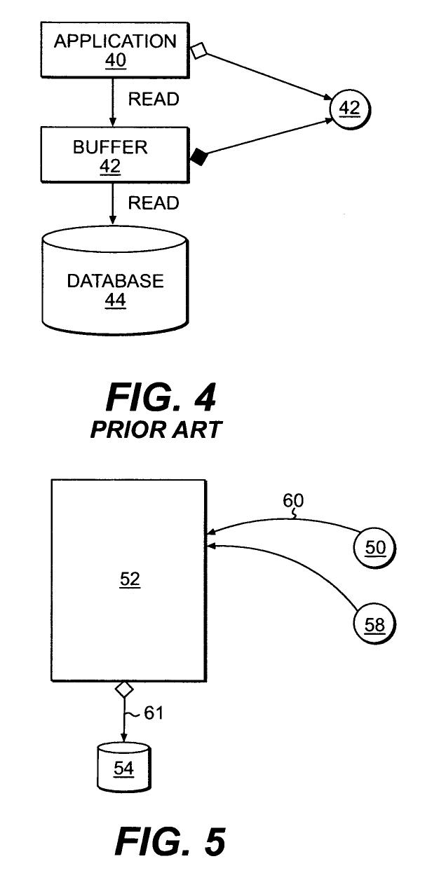

FIG. 4 illustrates a system known in the prior art, corresponding to the system illustrated in FIG. 2. The system comprises an application 40, a buffer 42, and a database 44. Application 40 may send a request for an object 46 to database 44 via buffer 42. Buffer 42 may create a copy of object 42 in transient memory, which is indirectly referenced by application 40.

FIG. 5 illustrates a system consistent with the principles of the present invention. The system may comprise an object instance, or proxy, 50, a buffer 52, a database 54 and an application (not pictured). Proxy 50 may comprise a symbolic object reference associated with an object contained in database 54. The symbolic object reference may contain the GUID of the requested object. When an application desires to access an object, it may engage proxy 50. Proxy 50 may dispatch the request to buffer 52, which may retrieve the content and return it to application 56. Buffer 52 need not store a copy of the object as is required in the system illustrated in FIG. 4. However, buffer 52 may store changes made to the object by the requesting application but not saved to the database. In one aspect, when responding to a request for the object, buffer 52 may determine whether it has already stored any content pertaining to the object, and if not, retrieve the object from database 54 and return it to application 56. If buffer 52 does contain edited content of the object not persistent on the database, it may update the object with the edited content before returning it to the requesting application. If the returned information is edited by application 56, the edited information is stored in buffer 52. As shown by arrow 60, proxy 50 references buffer 52, which in turn references database 54 (arrow 61) to provide the content of the object to application 56.

In this manner, the system may avoid providing inconsistent versions of the object to requesting applications. For example, if the application makes a second request for the previously requested object via a proxy 58, buffer 52 may retrieve the content of the requested object from database 54. Before passing the retrieved content to application 56 via proxy 58, buffer 52 may update the retrieved content with the previously edited portion of the object stored in transient memory. Because buffer 52 updates the second request with the content of the requested object edited (but not saved) in a current session, consistent versions of the object are provided in response to multiple proxy requests.

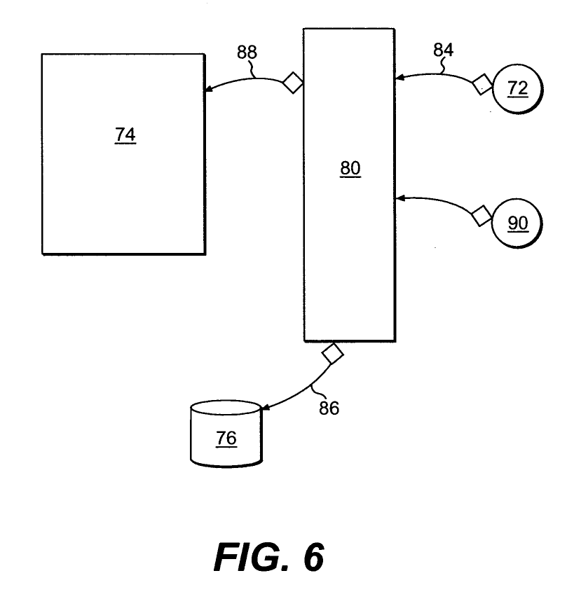

FIG. 6 illustrates another system consistent with the principles of the present invention. Like the system illustrated in FIG. 5, the system illustrated in FIG. 6 may comprise a proxy 72, a buffer 74, a database 76 and an application (not pictured). The system may also comprise a facade 80 operative to serve as an interface between proxy 72 and buffer 74, as well as between proxy 72 and database 76. Proxy 72 may be engaged to request the content of an object from database 76 on behalf of a requesting application by referencing facade 80. The request for the content of the object may be received by facade 80 (arrow 84) and transmitted to both database 76 (arrow 86) and buffer 74 (arrow 88). The content of the object may be retrieved from database 76 and returned to facade 80. Buffer 74 may determine, based on the GUID of the requested object, whether buffer 74 contains any edited content of the object not saved on database 76. If buffer 64 does contain edited content of the object, the system may update the content of the object received from database 76 before returning it to the application. Similarly, the application may make a second request for the object by engaging a second proxy 90. Second proxy 90 may request the content of the object via facade 80. Facade 80 may pass the request to buffer 74 and database 76. If buffer 74 contains any updated content of the object, the content received from database 76 may be modified with the updated content before the object is returned to the application.

As mentioned above, a database in accordance with the principles of the present invention may comprise a plurality of object types and record types. While an object and a record may have different meanings within a system or application, they may be processed similarly by a system consistent with the principles of the present invention. In one aspect consistent with the principles of the present invention, the system may comprise a separate buffer for each object type and each record type. Similarly, in aspects utilizing a facade, the system may comprise a separate buffer and facade for each object type and each record type contained in the system.

While certain features and embodiments of the invention have been described, other embodiments of the invention will be apparent to those skilled in the art from consideration of the specification and practice of the embodiments of the invention disclosed herein. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for reducing transient memory consumption in an object-oriented system, comprising:
transmitting a first request for content of an object from an application to a database via a buffer;
returning the requested content from the database to the application via the buffer;
upon the application editing a portion of the requested content, storing only the edited portion of the content in the buffer; and
upon the application transmitting a second request for the content of the object, retrieving the requested content from the database, determining whether the buffer contains any previously edited portion of the content and, if so, updating the content retrieved from the database with the edited portion before returning the requested content to the application.

2. The method of claim 1, wherein the object is associated with a globally unique identifier (GUID).

3. The method of claim 2, further comprising storing the edited portion of the content in the buffer in association with the object's GUID, and wherein the buffer determines whether it has stored edited content of a requested object by searching for the GUID of the requested object.

4. The method of claim 2, wherein transmitting the first request for the content of the object from the application to the database comprises creating a proxy containing the GUID of the requested object.

5. The method of claim 4, wherein the proxy references the buffer to retrieve the content of the object from the database, wherein further the buffer returns the content of the first object to the application via the proxy without storing the returned content.

6. The method of claim 4, wherein the proxy transmits the first request for the content of the object to a facade that references the database to retrieve the requested content and also references the buffer to determine whether the buffer has stored any edited portion of the requested content and, if so, to update the content retrieved from the database with the edited portion.

7. The method of claim 1, further comprising discarding the edited content from the buffer after the edited content is made persistent on the database.

8. The method of claim 1, further comprising, upon the first request for the content of the object, determining whether the buffer has already stored information relating to the requested object in a current session.

9. A system for reducing transient memory consumption in an object-oriented system, comprising:
(i) a database containing an object;
(ii) a proxy comprising a symbolic object reference associated with the object, wherein an application may retrieve content of the object through the proxy;
(iii) a buffer operative to store content of the object edited by the application; wherein in response to a request for an object from the proxy, the buffer is operative to determine whether the buffer has previously stored any edited content of the requested object and, if so, to update the content of the object retrieved from the database with the edited content before returning it to the application via the proxy.

10. The system of claim 9, wherein the symbolic object reference is a GUID associated with the requested object.

11. The system of claim 10, wherein the system is further operative to create, in response to a second request by the application for the same object during a single session, a second proxy referencing the database using the GUID of the requested object.

12. The system of claim 11, wherein, in response to the request for the object from the second proxy, the buffer is operative to retrieve the object content from the database and to determine, based on the GUID of the requested object, whether it has previously stored edited content of the object and, if so, to update the content retrieved from the database with the edited content before returning it to the application.

13. The system of claim 9, wherein the edited content is stored as lines in the buffer.

14. The system of claim 9, wherein the buffer is adapted to discard the edited content from transient memory after the edited content is made persistent on the database.

15. The system of claim 9, wherein the database contains a plurality of object types, wherein each object type is associated with a unique buffer.

16. The system of claim 9, further comprising a facade operative to serve as an interface between the proxy, the buffer and the database, wherein the facade is operative to receive object requests from the proxy and to return objects from the database to the proxy, wherein further the facade is operative to transmit object requests to the buffer to determine whether the buffer contains edited content of the requested object and, if so, to update the object returned from the database with the edited content before returning the object to the proxy.

17. The system of claim 16, further comprising a plurality of object types, wherein each object type is associated with a unique buffer and a unique facade.

18. A computer-readable medium which stores a set of instructions which when executed performs a method for reducing consumption of transient memory in an object-oriented system, the computer-readable medium executed by the set of instructions comprising:
(i) creating a proxy associated with an object contained in a database, the proxy being engageable by an application to request content of the object from the database;
(ii) engaging the proxy to request the object content from the database via a buffer;
(iii) retrieving the object content from the database;
(iv) determining whether the buffer contains content of the object edited by the application and, if so, updating the content of the object retrieved from the database with the edited content; and
(v) returning the content of the object to the requesting application via the proxy.

19. The computer-readable medium of claim 18, the set of instructions further comprising storing any portion of the content of the object edited by the requesting application in the buffer.

20. The computer-readable medium of claim 18, the set of instructions further comprising storing the edited portion of the content of the object in the buffer in association with a GUID of the object, and wherein further in response to a request from the proxy for the object, the buffer determining whether it contains any edited portion of the requested object's content by searching its memory storage for the GUID of the requested object.
